(19) United States
(12) Patent Application Publication
(10) Pub. No.: US 2010/0033400 A1
(43) Pub. Date: Feb. 11, 2010

(54) SPRAY NON-CONTACT CUTTING TYPE ANTENNA AND ITS FABRICATION METHOD

(76) Inventors: Daniel CHANG, Pa-Te City (TW); Chih-Wei Chang, Pa-Te City (TW)

Correspondence Address: BIRCH STEWART KOLASCH & BIRCH, PO BOX 747, FALLS CHURCH, VA, 22040-0747, US

(21) Appl. No.: 12/186,051

(22) Filed: Aug. 5, 2008

(51) Int. Cl. H01Q 1/40; B28B 11/12

(52) U.S. Cl. 343/873; 264/162

(57) ABSTRACT

A spray non-contact cutting type antenna fabrication method is disclosed to have an antenna radiator be formed on a plastic shell by means of spray-painting a metallic spray paint on the surface of the plastic shell and then cutting the metallic coating into shape, and then to cover the plastic shell with a cover layer by means of an insert molding or spray paining technique to have the antenna radiator be enveloped in the cover layer.

### BACKGROUND OF THE INVENTION

1. Field of the Invention

The present invention relates to an antenna fabrication method and more particularly, to a spray non-contact cutting type antenna fabrication method for forming an antenna on a plastic shell by means of spray-painting a metallic spray paint on the plastic shell and then cutting the metallic coating into shape and then covering a cover layer on the plastic shell over the antenna by means of an insert molding technique.

2. Description of the Related Art

Following fast development of wireless communication technology, mobile telephone has become the most important communication tool for most people. From the early mobile telephone designs of big size, exposed antenna, monotonous outer appearance and simple function, modern mobile telephones have light, thin, small and short characteristics with the antenna concealed from sight. Clamshell, slip cover and flip cover mobile telephones are commercially available. Advanced mobile telephones have added functions such as network, camera, MP3 player, and etc. Nowadays, except for message communication, an advanced mobile telephone can function as a multimedia entertainment system.

Following the design trend toward small size and light weight characteristics with built-in multifunction module, the usable internal space of a mobile telephone has been greatly reduced. In consequence, the space for microwave transmitting and receiving radiator (the so-called antenna) is relatively reduced. Therefore, how to provide a fabrication method for making concealed antenna in a device shell to save space occupation is the focal point to be discussed in the present invention.

Conventionally, the installation of a cell phone antenna in a device shell is complicated. After cutting the antenna into the desired shape, a series of procedures including posterior assembly and thermal fusion/ultrasonic sealing must be performed, wasting much manufacturing time and having a defect rate. Therefore, an improvement is this regard is necessary.

U.S. Pat. No. 7,271,099 discloses an antenna fabrication method, entitled “Forming a conductive pattern on a substrate”. This method comprises: a) providing a substrate carrying a conductive layer; b) forming a first portion of the conductive pattern by exposing the conductive layer to a laser and controlling the laser to remove conductive material around the edge(s) of desired conductive region(s) of the first portion; and, c) laying down an etch resistant material on the conductive layer, the etch resistant material defining a second portion of the conductive pattern, removing conductive material from those areas of the second portion not covered by the etch resistant material, and then removing the etch resistant material, wherein the first portion of a conductive pattern is formed at a higher resolution than the second portion of the conductive pattern.

The aforesaid prior art pattern simply provides a method of forming a conductive pattern on a flexible insulative material (such as circuit board) by means of the application of a laser technique. This method is not applicable to the formation of a conductive pattern on a rigid plastic device shell, therefore it is not suitable for antenna fabrication.

### SUMMARY OF THE INVENTION

The present invention has been accomplished under the circumstances in view. The design concept of the present invention is to form the antenna radiator by means of spray-painting a conducting material onto the surface of the prepared plastic device shell, and then to remove the unnecessary conducting material from the plastic device shell through a posterior processing process, and then to package the antenna radiator in the device shell by means of a 2-step insert molding or spray-painting process.

A spray non-contact cutting type antenna fabrication method according to the present invention comprises the steps of:

a) forming a plastic shell;

b) spray-painting the plastic shell with a metallic spray paint to form a metal coating layer on the plastic shell;

c) cutting the metal coating layer into an antenna subject to a predetermined pattern; and

d) covering the plastic shell with a cover layer to have the antenna be enveloped in the cover layer.

A device shell having a spray non-contact cutting type antenna made according to the present invention has the antenna be incorporated into the plastic shell without occupying any extra space. When compared with conventional manufacturing techniques, the invention eliminates posterior assembly and thermal fusion/ultrasonic sealing processes, saving much manufacturing time and lowering the defect rate.

### BRIEF DESCRIPTION OF THE DRAWINGS

FIG. 1 is a manufacturing flow chart of the present invention.

FIG. 2 is a schematic drawing showing the first step of the spray non-contact cutting type antenna fabrication method according to the present invention.

FIG. 3 is a schematic drawing showing the second step of the spray non-contact cutting type antenna fabrication method according to the present invention.

FIG. 4 is a schematic drawing showing the third step of the spray non-contact cutting type antenna fabrication method according to the present invention.

FIG. 5 is a schematic drawing showing the fourth step of the spray non-contact cutting type antenna fabrication method according to the present invention.

FIG. 6 is a perspective view of a device shell with a spray non-contact cutting type antenna made according to the present invention.

FIG. 7 is an exploded view of the device shell shown in FIG. 6.

### DETAILED DESCRIPTION OF THE PREFERRED EMBODIMENT

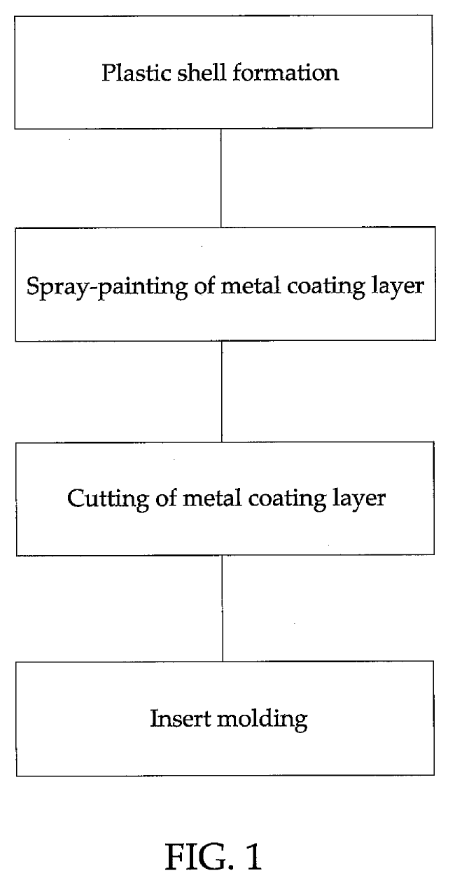

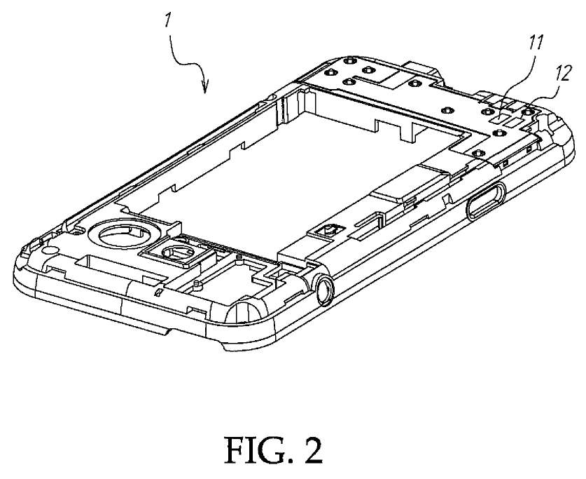

Referring to FIG. 1 and FIGS. 2˜5, a spray non-contact cutting type antenna fabrication method in accordance with the present invention includes the following four steps:

1. form a plastic shell 1, as shown in FIG. 2;

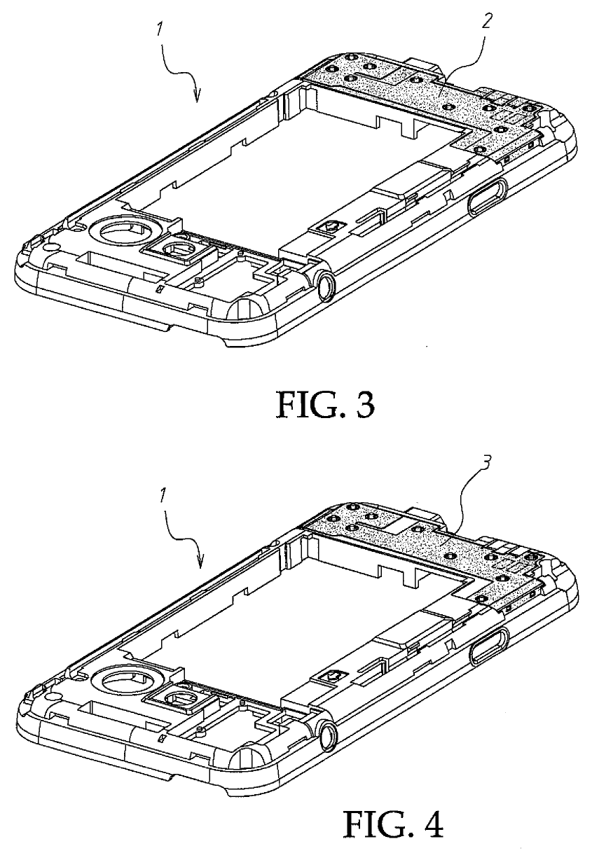

2. spray-paint the plastic shell 1 with a metallic spray paint, thereby forming a metal coating layer 2 on the surface of the assigned part of the plastic shell 1, as shown in FIG. 3;

3. cut the metal coating layer 2 into an antenna 3 subject to a predetermined pattern by means of, for example, a laser engraving technique, as shown in FIG. 4; and

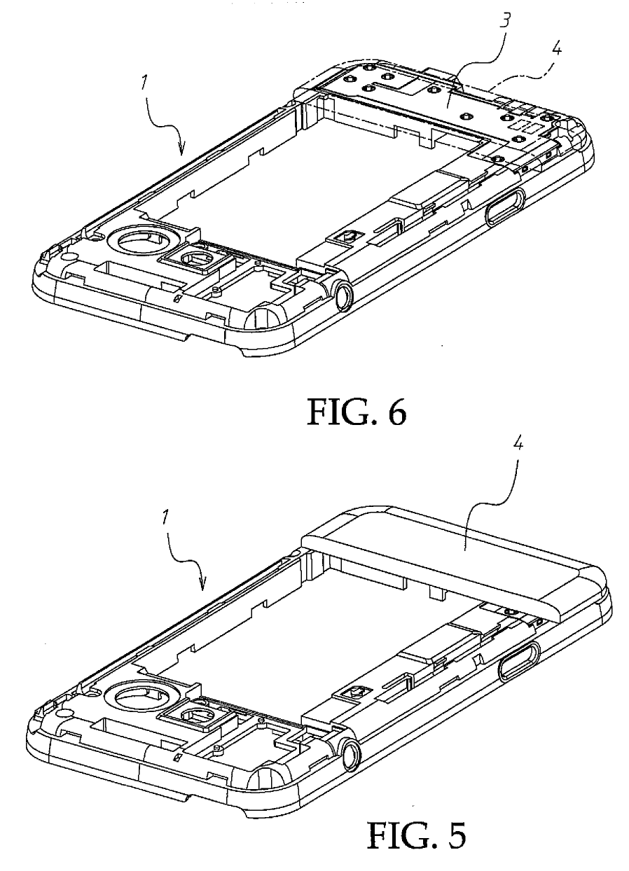

4. cover the plastic shell 1 with a cover layer 4 by means of using an insert molding or spray painting technique to have the antenna 3 be enveloped in the cover layer 4, as shown in FIG. 5).

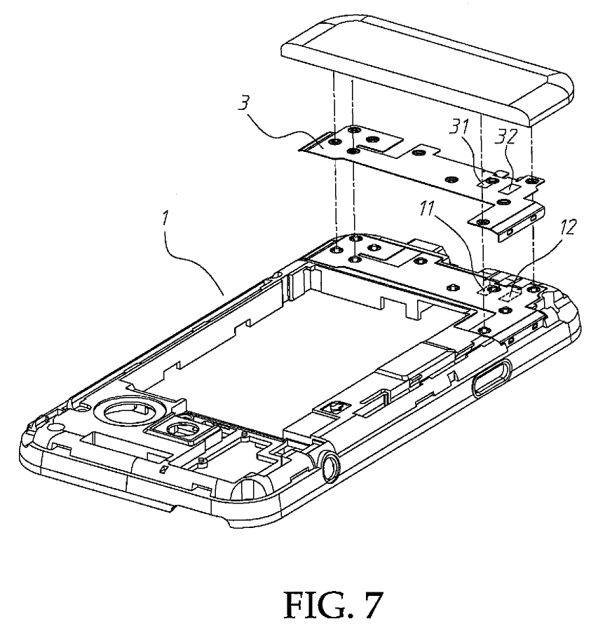

Referring to FIGS. 6 and 7, the plastic shell 1 has a feed-in contact hole 11 and a grounding contact hole 12. When spray-painting the plastic shell 1 with a metallic spray paint to form a metal coating layer for cutting into an antenna, a feed-in contact 31 and a grounding contact 32 are respectively formed of the metallic spray paint in the feed-in contact hole 11 and a grounding contact hole 12 for connection to a respective contact at a circuit board (not shown) to be mounted in the plastic shell 1.

A device shell having a spray non-contact cutting type antenna made according to the present invention, as shown in FIGS. 6 and 7, comprises a plastic shell 1, an antenna 3, and a cover layer 4.

The plastic shell 1 has a feed-in contact hole 11 and a grounding contact hole 12. The antenna 3 is made by means of spray-painting a metallic spray paint onto the surface plastic shell 1 and then cutting the metallic coating into shape. The cover layer 4 is covered on the plastic shell 1 over the antenna 3 through an insert molding technique. Further, the antenna 3 has a feed-in contact 31 and a grounding contact 32 respectively extended to the inside of the feed-in contact hole 11 and grounding contact hole 12 of the plastic shell 1 for electric connection to a respective contact at a circuit board (not shown) inside the plastic shell 1.

A device shell having a spray non-contact cutting type antenna made according to the present invention has the antenna 3 be incorporated into the plastic shell 1 without occupying any extra space. When compared with conventional manufacturing techniques, the invention eliminates posterior assembly and thermal fusion/ultrasonic sealing processes, saving much manufacturing time and lowering the defect rate.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A spray non-contact cutting type antenna fabrication method, comprising the steps of:
a) forming a plastic shell;
b) spray-painting said plastic shell with a metallic spray paint to form a metal coating layer on said plastic shell;
c) cutting said metal coating layer into an antenna subject to a predetermined pattern; and
d) covering said plastic shell with a cover layer by means of an insert molding technique to have said antenna be enveloped in said cover layer.

2. The spray non-contact cutting type antenna fabrication method as claimed in claim 1, wherein said plastic shell has a feed-in contact hole and a grounding contact hole; the step b) of spray-painting said plastic shell with a metallic spray paint to form a metal coating layer on said plastic shell is to have said metallic spray paint be coated in said feed-in contact hole and said grounding contact hole to form therein a feed-in contact and a grounding contact.

3. A spray non-contact cutting type antenna fabrication method, comprising the steps of:
a) forming a plastic shell;
b) spray-painting said plastic shell with a metallic spray paint to form a metal coating layer on said plastic shell;
c) cutting said metal coating layer into an antenna subject to a predetermined pattern; and
d) covering said plastic shell with a cover layer by means of a spray painting technique to have said antenna be enveloped in said cover layer.

4. A device shell comprising:
a plastic shell;
an antenna formed of a metallic spray paint been spray-painted on said plastic shell and cut into shape subject to a predetermined pattern; and
a cover layer covered on said plastic shell over said antenna by means of an insert molding technique.

5. The device shell as claimed in claim 4, wherein said plastic shell comprises a feed-in contact hole and a grounding contact hole; said antenna comprises a feed-in contact and a grounding contact respectively extended to the inside of said feed-in contact hole and said grounding contact hole.
